(19) United States
(12) Patent Application Publication
(10) Pub. No.: US 2003/0025390 A1
(43) Pub. Date: Feb. 6, 2003

(54) Solenoid drive circuit

(76) Inventors: Hiromi Inagaki, Wako-shi (JP); Hideki Hiratsuka, Wako-shi (JP); Hidetoshi Kobori, Wako-shi (JP)

Correspondence Address: ARENT FOX KINTNER PLOTKIN & KAHN, PLLC, Suite 400, 1050 Connecticut Avenue, N.W., Washington, DC, 20036-5339, US

(21) Appl. No.: 10/199,321

(22) Filed: Jul. 22, 2002

(30) Foreign Application Priority Data
Jul. 27, 2001 (JP) 2001-227138

(51) Int. Cl. B60T 8/78

(52) U.S. Cl. 303/199

(57) ABSTRACT

A solenoid drive circuit is provided with an energization controller that controls the energization/de-energization of a coil and is disposed either between a power source and the coil or between the coil and ground. A diode allows electric current to flow toward the power source and is connected between the power source and ground while bypassing the coil. A switch is provided either between the power source and the diode or between the diode and ground. Therefore, it is possible to easily switch between a state in which the electric current flowing through the coil is gradually reduced and a state in which the electric current flowing through the coil is rapidly reduced by switching over between conduction and cutoff of the switch.

### BACKGROUND OF THE INVENTION

1. Technical Field of the Invention

The present invention relates to a solenoid drive circuit in which an energization controller that controls the energization/de-energization of a coil is provided either between a power source and the coil or between the coil and ground, and a diode, which allows electric current to flow toward the power source, that is connected between the power source and ground while bypassing the coil.

2. Related Art

A conventional solenoid drive circuit is known, such as, for example, the circuit disclosed in published Japanese translation No. 10-504259 of a PCT application.

In the conventional solenoid drive circuit, the diode is used to gradually reduce the electric current flowing through the coil when energization of the coil is stopped. Furthermore, in the conventional solenoid drive circuit, the diode also functions to prevent the occurrence of noise due to a valve body hitting a valve seat when a solenoid valve closes.

In the case of a solenoid valve employing a coil, a rapid switch over operation of the solenoid valve by de-energizing the coil is sometimes required. However, if the electric current flowing through the coil is gradually reduced by the diode, the rapid switch over operation of the solenoid valve is not possible.

### SUMMARY OF THE INVENTION

It is an object of the present invention to at least overcome the above-described deficiencies of the conventional solenoid drive circuit.

It is also an object of the present invention to provide a solenoid drive circuit that can easily switch over between a state in which the electric current flowing through a coil is gradually reduced and a state in which the electric current flowing through the coil is rapidly reduced.

In accordance with a preferred embodiment of the present invention, a solenoid drive circuit includes an energization control means which controls the energization/de-energization of a coil and which is provided either between a power source and the coil or between the coil and ground. A diode that allows electric current to flow toward the power source is connected between the power source and ground while bypassing the coil. The solenoid drive circuit also includes switch means provided either between the power source and the diode or between the diode and ground.

Because of the above-described structural arrangement, switching over the conduction/cutoff of the switch means facilitates switching between a state in which the diode is active and a state in which the diode is substantially inactive. Therefore, it is possible to easily switch over between a state in which the electric current flowing through a coil is gradually reduced and a state in which the electric current flowing through the coil is rapidly reduced by switching the switch means between conduction and cutoff.

### BRIEF DESCRIPTION OF DRAWINGS

A structural arrangement and method for carrying out the present invention is described below by reference to a preferred embodiment of the present invention shown in the attached drawings, wherein:

FIG. 1 is a schematic diagram of a brake fluid pressure circuit of a passenger vehicle brake system;

FIG. 2 is a cross-sectional side view of a normally open solenoid valve used in the circuit shown in FIG. 1;

FIG. 3 is a graph illustrating the change in attractive force between the fixed core and armature of the solenoid valve shown in FIG. 2 with the change in stroke of a valve stem;

FIG. 4 is a schematic diagram showing the arrangement of a drive circuit of the normally open solenoid valve shown in FIG. 1 in a controller according to a preferred embodiment of the present invention;

FIG. 5A is a graph illustrating the gradual change in electric current passing through the coil when the switch means provides conduction between the diode and ground of the drive circuit shown in FIG. 4; and

FIG. 5B is a graph illustrating the rapid reduction in electric current passing through the coil when the switch means cuts off conduction between the diode and ground of the drive circuit shown in FIG. 4.

### DETAILED DESCRIPTION OF THE INVENTION

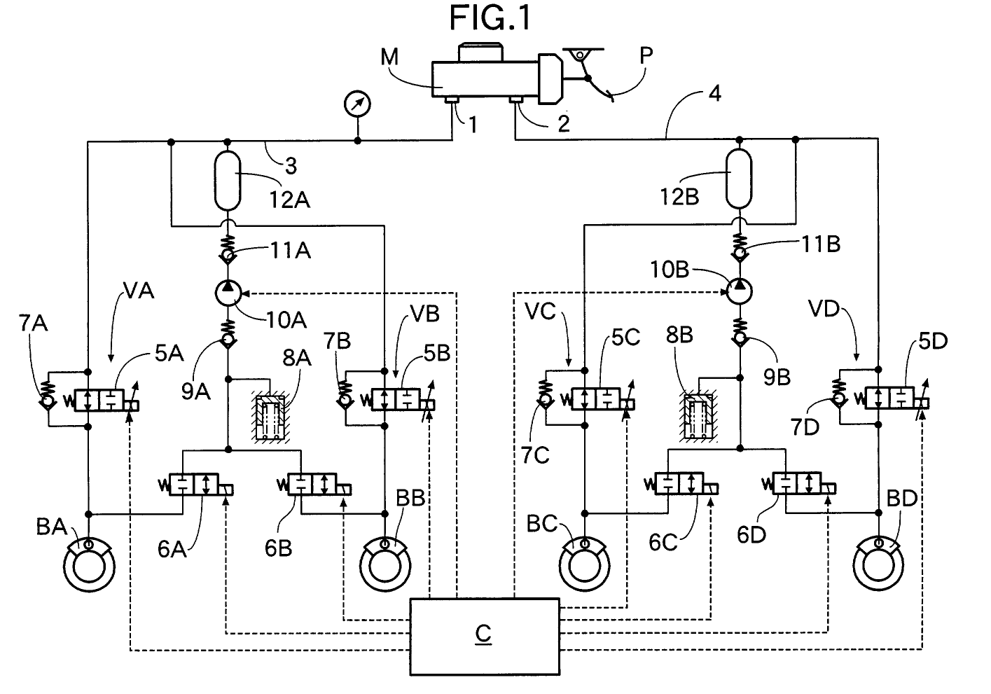

Referring to FIG. 1, a tandem master cylinder M includes first and second output ports 1 and 2 that generate a brake fluid pressure according to the pressure applied to a brake pedal P by the foot of a vehicle driver. Fluid pressure control valve means VA and VB are provided between a first output fluid pressure path 3 connected to the first output port 1, and a left front wheel brake BA and right rear wheel brake BB, respectively. Fluid pressure control valve means VC and VD are provided between a second output fluid pressure path 4 connected to the second output port 2, and a right front wheel brake BC and left rear wheel brake BD, respectively.

The fluid pressure control valve means VA to VD include normally open solenoid valves 5A to 5D, respectively. The solenoid valves 5A to 5D correspond to the left front wheel brake BA, right rear wheel brake BB, right front wheel brake BC, and left rear wheel brake BD, respectively. Check valves 7A to 7D are connected in parallel to a corresponding normally open solenoid valve 5A to 5D. A normally closed solenoid valve 6A to 6D is provided for a corresponding wheel brake BA to BD.

The normally open solenoid valves 5A and 5B corresponding to the first output fluid pressure path 3 are disposed between the first output fluid pressure path 3, and the left front wheel brake BA and right rear wheel brake BB. The normally closed solenoid valves 6A and 6B corresponding to the first output fluid pressure path 3 are disposed between a single first reservoir 8A, the left front wheel brake BA, and the right rear wheel brake BB. Connected to the first reservoir 8A, via a first suction valve 9A, is the suction side of a first pump 10A capable of drawing brake fluid from the first reservoir 8A. The discharge side of the first pump 10A is connected to the first output fluid pressure path 3 via a first discharge valve 11A and a first damper 12A.

The normally open solenoid valves 5C and 5D corresponding to the second output fluid pressure path 4 are disposed between the second output fluid pressure path 4, and the right front wheel brake BC and left rear wheel brake BD. The normally closed solenoid valves 6C and 6D corresponding to the second output fluid pressure path 4 are disposed between a single second reservoir 8B, the right front wheel brake BC, and the left rear wheel brake BD. Connected to the second reservoir 8B, via a second suction valve 9B, is the suction side of a second pump 10B capable of drawing brake fluid from the second reservoir 8B. The discharge side of the second pump 10B is connected to the second output fluid pressure path 4 via a second discharge valve 11 B and a second damper 12B.

Each check valve 7A to 7D is connected, in parallel, to a corresponding normally open solenoid valve 5A to 5D so as to allow the brake fluid to flow from the corresponding wheel brake BA to BD to the master cylinder M.

A controller C controls operation of the fluid pressure control valve means VA to VD. In other words, the controller C controls operation of the normally open solenoid valves 5A to 5D, the normally closed solenoid valves 6A to 6D, and the first and second pumps 10A and 10B.

During normal braking when there is no possibility of the wheels locking, the fluid pressure control valve means VA to VD are controlled by the controller C so as to provide communication between the master cylinder M and the wheel brakes BA to BD while blocking communication between the wheel brakes BA to BD and the reservoirs 8A and 8B. In other words, the normally closed solenoid valves 6A to 6D are each in a closed state since they are de-energized, and the normally open solenoid valves 5A to 5D are each in an open state since they are de-energized. As a result, the brake fluid pressure output from the first output port 1 of the master cylinder M is applied to the left front wheel brake BA via the normally open solenoid valve 5A and to the right rear wheel brake BB via the normally open solenoid valve 5B. Also, the brake fluid pressure output from the second output port 2 of the master cylinder M is applied to the right front wheel brake BC via the normally open solenoid valve 5C and to the left rear wheel brake BD via the normally open solenoid valve 5D.

When a wheel is about to lock during braking, among the fluid pressure control valve means VA to VD, the controller C controls the fluid pressure control valve means corresponding to the wheel that is about to lock so that communication between the master cylinder M and the wheel brake BA to BD is blocked and communication between the wheel brake BA to BD and the corresponding reservoir 8A or 8B is provided. In other words, among the normally open solenoid valves 5A to 5D, the normally open solenoid valve corresponding to the wheel that is about to lock is closed by energizing the corresponding normally open solenoid valve. Likewise, the normally closed solenoid valve 6A to 6D corresponding to the wheel that is about to lock is opened by energizing the corresponding normally closed solenoid valve. In this way, a part of the brake fluid pressure of the wheel that is about to lock is absorbed by the first reservoir 8A or the second reservoir 8B, thereby reducing the brake fluid pressure of the wheel that is about to lock.

When a constant brake fluid pressure is maintained, the controller C controls the fluid pressure control valve means VA to VD so that the wheel brakes BA to BD are cut off from the master cylinder M and the reservoirs 8A and 8B. In other words, the normally open solenoid valves 5A to 5D are closed by energizing them while simultaneously the normally closed solenoid valves 6A to 6D are closed by de-energizing them. When the brake fluid pressure is increased, the normally closed solenoid valves 6A to 6D are closed by de-energizing them, and at the same time, by controlling the electric current applied to the normally open solenoid valves 5A to 5D, the fluid pressure on the downstream side of the normally open solenoid valves 5A to 5D is linearly controlled according to the applied electric current.

The first and second pumps 10A and 10B are controlled by the controller C so as to operate when the above-mentioned anti-lock brake control is occurring, and the brake fluid in the first and second reservoirs 8A and 8B is returned to the master cylinder M side via the first and second pumps 10A and 10B. Returning the brake fluid in this way prevents any increase in the depression amount of the brake pedal P due to the brake fluid absorbed by the first and second reservoirs 8A and 8B. Moreover, since pulsations in the discharge pressure of the first and second pumps 10A and 10B can be absorbed by the first and second dampers 12A and 12B, the return of brake fluid does not interfere with the operational feel of the brake pedal P.

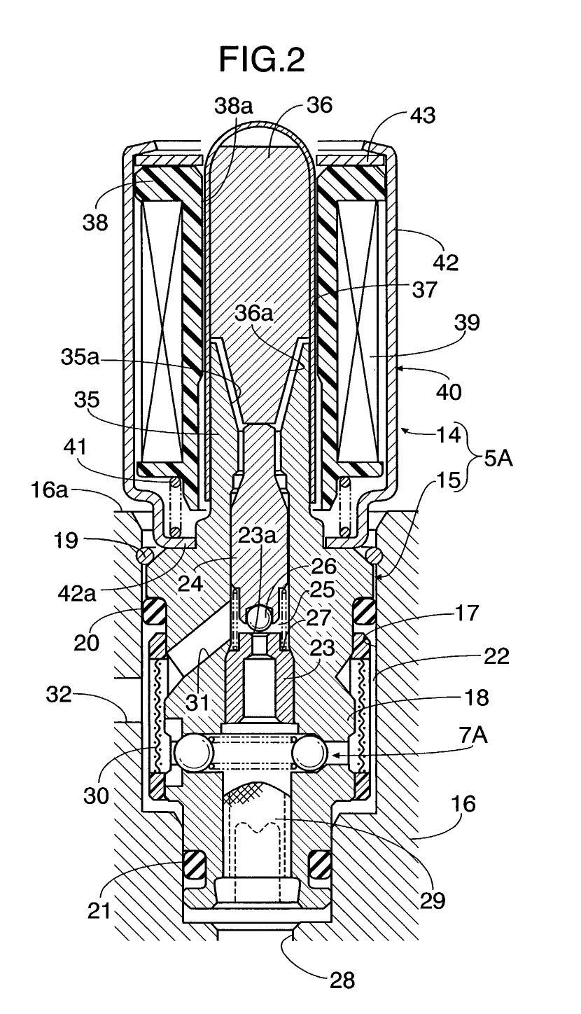

When anti-lock brake control is carried out in this way, on and off control of the normally closed solenoid valves 6A to 6D is carried out by the controller C. The normally open solenoid valves 5A to 5D are controlled by an intermediate value of electric current between on and off as well as by the on and off control. Among the normally open solenoid valves 5A to 5D which are arranged so as to change the fluid pressure on the wheel brake BA to BD side linearly according to the electric current applied at such an intermediate value, the arrangement of the normally open solenoid valve 5A is explained below by reference to FIG. 2.

In FIG. 2, the normally open solenoid valve 5A is formed from a solenoid part 14 that exerts an electromagnetic force and a valve part 15 driven by the solenoid part 14. The valve part 15 is housed within a mounting hole 17 provided in a fixed support block 16 and opens on one face 16a of the support block 16. The solenoid part 14 extends from the one face 16a of the support block 16.

The valve part 15 includes a valve housing 18 formed from magnetic metal in the shape of a stepped cylinder. The valve housing 18 is fitted within the mounting hole 17 of the support block 16. Fitted on the inner face of the mounting hole 17 toward the open end is a stop ring 19 which engages the valve housing 18 to prevent the valve housing 18 from detaching from the mounting hole 17. Annular seals 20 and 21 are mounted on the outer face of the valve housing 18 in two positions spaced apart from each other in the axial direction. An annular chamber 22 is formed between the seals 20 and 21 and between the support block 16 and the valve housing 18.

A cylindrical valve seat member 23 is press-fit and fixed within the valve housing 18. Furthermore, slidably fit within the valve housing 18 is a non-magnetic valve stem 24. An output chamber 25 is formed between a lower end of the valve stem 24 and the valve seat member 23. Fixed to the lower end of the valve stem 24 is a spherical valve body 26 positionable on a valve seat 23a formed in the valve seat member 23 so as to face the output chamber 25. Moreover, disposed between the lower end of the valve stem 24 and the valve seat member 23 is a return spring 27 which biases the valve stem 24, that is, the valve body 26, in a direction so as to unseat the valve body 26 from the valve seat member 23.

A filter 29 mounted in the valve housing 18 is disposed between the valve seat member 23 and a fluid pressure path 28 provided in the support block 16 so as to communicate with the first output fluid pressure path 3. Furthermore, another filter 30 is mounted around the outer surface of the valve housing 18 in a region so as to face or oppose the annular chamber 22. A passage 31 disposed in the valve housing 18 provides communication between the output chamber 25 and the annular chamber 22 via the filter 30. The annular chamber 22 communicates with the wheel brake BA through a fluid pressure path 32 provided in the support block 16. Moreover, disposed in the valve housing 18 between the valve seat member 23 and the filter 29 is the check valve 7A that opens when the pressure of the fluid pressure path 28 becomes lower than that of the annular chamber 22, thus returning the brake fluid of the annular chamber 22 to the fluid pressure path 28 side.

The solenoid part 14 includes a fixed core 35 with an armature 36 coaxially connected to the upper end of the valve stem 24 of the valve part 15 and facing the fixed core 35. A guide tube 37 guides the movement of the armature 36 toward and away from the fixed core 35. A bobbin 38 surrounds the guide tube 37. A coil 39 is wound around the bobbin 38 with a magnetic path frame 40 surrounding the coil 39. Also, a coil spring 41 is disposed between the magnetic path frame 40 and the bobbin 38.

The fixed core 35 has a cylindrical shape and is coaxially connected, in an integral manner, to the center of a first end of the valve housing 18. The guide tube 37 is formed from a non-magnetic material, such as, for example only, stainless steel, in a thin, bottomed cylindrical shape with a hemispherical closed end. Fitted into the open end of the guide tube 37 is an extremity of the fixed core 35, wherein the open end of the guide tube 37 is secured to the fixed core 35 by, for example, welding. When the valve housing 18 is mounted in the mounting hole 17, the guide tube 37 extends from the face 16a of the support block 16.

The bobbin 38 is formed from a synthetic resin so as to have a center hole 38a through which the guide tube 37 runs, and the coil 39 is wound around the bobbin 38.

The magnetic path frame 40 includes a magnetic path tube 42 surrounding the bobbin 38 and coil 39. Joined by caulking to one end of the magnetic path tube 42 is a ring-shaped magnetic path plate 43 that is in contact with the bobbin 38 so that the closed end of the guide tube 37 extends from the center of the plate 43.

Integral with the other end of the magnetic path frame 42 is a ring-shaped contact plate 42a that contacts the first end of the valve housing 18 around the fixed core 35. The base part of the fixed core 35 mates with the inner circumference of the contact plate 42a. One end of the coil spring 41 contacts the contact plate 42a while the other end of the coil spring contacts the bobbin 38.

Housed within the guide tube 37 is the armature 36 which is movable toward and away from the fixed core 35. The upper end of the valve stem 24 which movably runs through the fixed core 35 is in coaxial contact with the armature 36. Since the valve stem 24 is biased by the spring force of the return spring 27 in a direction so as to unseat the valve body 26 from the valve seat member 23, and the upper end of the valve stem 24 is in constant contact with the armature 36, the valve stem 24, that is, the valve body 26, moves in the axial direction in response to the axial movement of the armature 36.

When there is no magnetic force to attract the armature 36 toward the fixed core 35, the armature 36 is moved back by the spring force of the return spring 27 to a position where it is received by the closed end of the guide tube 37. In this position, the valve body 26 is unseated from the valve seat member 23, and the normally open solenoid valve 5A is open. When the armature 36 is magnetically attracted toward the fixed core 35 until the valve body 26 is seated on the valve seat member 23, the normally open solenoid valve 5A is closed.

The resultant of the fluid pressure force due to the fluid pressure of the output chamber 25 and the spring force of the return spring 27 acts on the lower end of the valve stem 24, and a magnetic attraction force that attracts the armature 36 toward the fixed core 35 acts on the upper end of the valve stem 24. As a result, the valve stem 24 undergoes a stroke motion so that the resultant of the fluid pressure force and the spring force balances the magnetic attraction force. Controlling the amount of electric current applied to the coil 39 by, for example, duty control of the controller C so that the amount is at an intermediate value between the on and off values, changes the magnetic attraction force that attracts the armature 36 toward the fixed core 35.

Tapered opposing faces 35a and 36a of the fixed core 35 and the armature 36 each have a diameter that increases in a direction away from the output chamber 25.

The tapered shape of the opposing faces 35a and 36a of the fixed core 35 and the armature 36 permits the change in the opposite distance, that is, the distance in a direction perpendicular to the tapered faces, between the fixed core 35 and the armature 36 to be small relative to the travel distance of the axial stroke of the armature 36, so that the change in the attractive force generated between the opposing faces 35a and 36a is smaller than the change in the axial stroke of the armature 36. The actual attractive force in the axial direction is the component of the attractive force generated between the opposing faces 35a and 36a. Accordingly, the sharper the angle of the tapered faces, the smaller the change in axial attractive force relative to the change in attractive force between the opposing faces 35a and 36a.

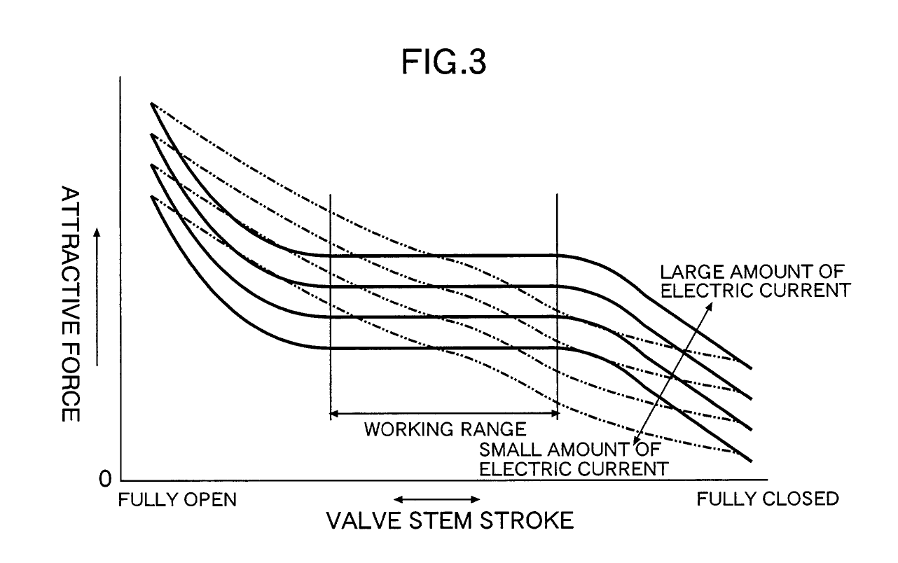

As shown by the solid lines in FIG. 3, the attractive force between the fixed core 35 and the armature 36 is substantially flat or constant in a working range between the fully closed state and the fully open state of the valve part 15. On the other hand, when the opposing faces 35a and 36a of the fixed core 35 and the armature 36 are flat and perpendicular relative to the axial direction, since the opposing distance between the fixed core 35 and the armature 36 varies proportional to the axial stroke of the valve stem 24, the attractive force between the fixed core 35 and the armature 36 varies or is not constant in the working range, as shown by the broken lines in FIG. 3.

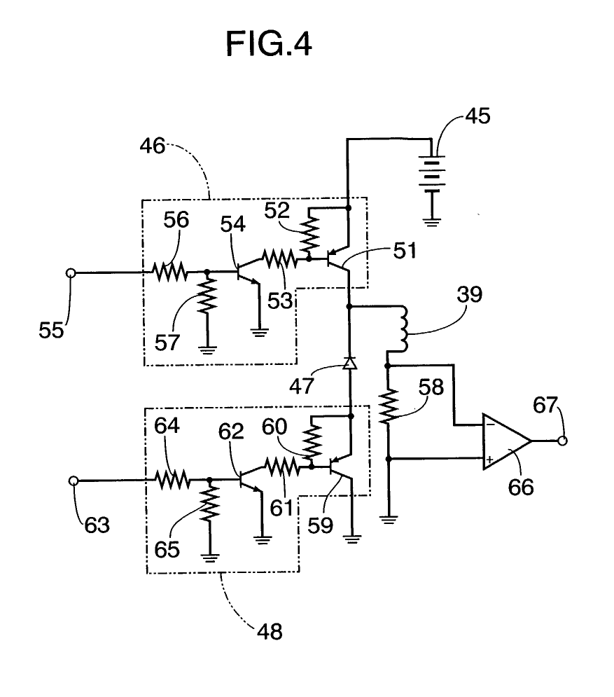

The controller C includes a drive circuit, shown in FIG. 4, that drives the normally open solenoid valve 5A. The drive circuit includes energization control means 46 provided between a power source 45 and the coil 39 to control the energization/de-energization of the coil 39. A diode 47 is connected between the power source 45 and ground while bypassing the coil 39. Switch means 48 is provided between the diode 47 and ground.

The energization control means 46 includes a PNP transistor 51 having an emitter connected to the power source 45. Resistors 52 and 53 and an NPN transistor 54 are connected in series between the power source 45 and ground. Resistors 56 and 57 are connected in series between a control signal input terminal 55 and ground. The junction between the resistors 52 and 53 is connected to the base of the PNP transistor 51, and the junction between the resistors 56 and 57 is connected to the base of the NPN transistor 54.

The NPN transistor 55 conducts in response to a high level control signal being input into the control signal input terminal 55, which results in the PNP transistor 51 conducting.

The coil 39 is connected to the collector of the PNP transistor 51 and grounded via a resistor 58. The diode 47 is connected to the collector of the PNP transistor 51 to allow electric current to flow toward the power source 45.

The switch means 48 includes a PNP transistor 59 having an emitter connected to the diode 47. Resistors 60 and 61 and an NPN transistor 62 are connected in series between the diode 47 and ground. Resistors 64 and 65 are connected in series between a control signal input terminal 63 and ground. The junction between the resistors 60 and 61 is connected to the base of the PNP transistor 59, and the junction between the resistors 64 and 65 is connected to the base of the NPN transistor 62.

The NPN transistor 62 conducts in response to a high level control signal being input into the control signal input terminal 63, which results in the PNP transistor 59 conducting.

An amplifier 66 is connected across opposite ends of the resistor 58 and the output of the amplifier 66 is output from a terminal 67. The output from the terminal 67 is used for feedback control of the energizing electric current provided to the coil 39.

In the drive circuit, the diode 47 gradually reduces the electric current flowing through the coil 39 when energization of the coil 39 is stopped. Although the diode 47 exhibits this function when the switch means 48 provides conduction between the diode 47 and ground, the diode 47 does not exhibit this function when the switch means 48 cuts off conduction between the diode 47 and ground.

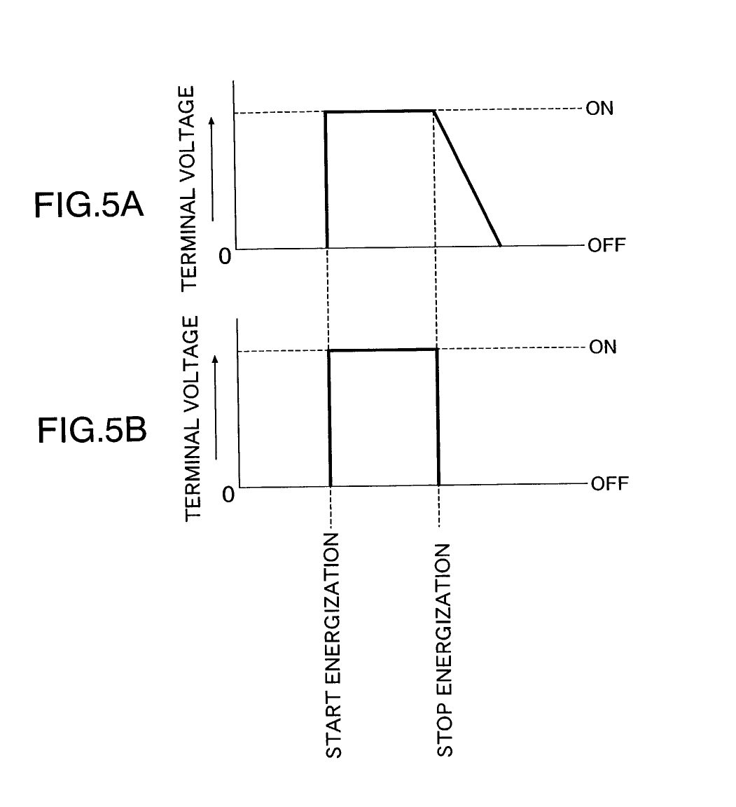

In other words, when the switch means 48 provides conduction between the diode 47 and ground, the electric current passing through the coil 39 gradually decreases when energization the coil 39 is stopped, as shown in FIG. 5A. When the switch means 48 cuts off conduction between the diode 47 and ground, the electric current passing through the coil 39 rapidly reduces when energization of the coil 39 is stopped, as shown in FIG. 5B.

The other normally open solenoid valves 5B, 5C, and 5D have the same arrangement as that of the normally open solenoid valve 5A.

Next, the operation of the preferred embodiment is explained. In the normally open solenoid valves 5A to 5D disposed between the master cylinder M and the corresponding wheel brake BA to BD, the opposing faces 35a and 36a of the fixed core 35 and the armature 36 are formed to be tapered in shape, and the amount of electric current applied to the coil 39 is controlled by the controller C so as to be on or off, or at an intermediate value between the on and off values.

In the normally open solenoid valves 5A to 5D, since the attractive force between the fixed core 35 and the armature 36 may be freely changed and, moreover, the opposing faces 35a and 36a of the fixed core 35 and the armature 36 are tapered, the change in the opposing distance between the fixed core 35 and the armature 36 is small compared with the amount of axial stroke of the armature 36, and the attractive force between the fixed core 35 and the armature 36 is substantially flat or constant in the working range, as shown in FIG. 3.

The valve stem 24 therefore operates so that the force acting on the lower end of the valve stem 24 based on the fluid pressure of the output chamber 25, that is, the output fluid pressure of the normally open solenoid valves 5A to 5D, balances the attractive force acting on the armature 36. Accordingly, the brake fluid pressure is linearly controlled by the normally open solenoid valves 5A to 5D, and the fluid pressure on the wheel brakes BA to BD side is linearly changed. It is thus possible to improve the operational feeling of the brake pedal P by preventing kick-back from occurring in the master cylinder M.

The normally closed solenoid valves 6A to 6D disposed between the reservoirs 8A and 8B and the wheel brakes BA to BD are controlled so as to be on or off. The normally closed solenoid valves 6A to 6D are closed to reliably prevent leakage of the brake fluid when the fluid pressure is linearly controlled by the normally open solenoid valves 5A to 5D. Thus, the precision of brake pressure control of the wheel brakes BA to BD is enhanced.

Furthermore, since the normally open solenoid valves 5A to 5D are formed to be linear by slightly modifying a conventional on/off normally open solenoid valve, the dimensions do not increase, thus avoiding any increase in the dimensions of the fluid pressure control valve means VA to VD.

The drive circuit of the controller C for driving the normally open solenoid valves 5A to 5D includes the energization control means 46 provided between the power source 45 and the coil 39 so as to control the energization/de-energization of the coil 39. The diode 47 is connected between the power source 45 and ground while bypassing the coil 39. The switch means 48 is provided between the diode 47 and ground. Switching over the switch means 48 between conduction and cutoff results in the switching over between a state in which the diode 47 is active and a state in which the diode 47 is substantially inactivated.

It is therefore possible to easily switch over between a state in which the electric current flowing through the coil 39 is gradually reduced and a state in which the electric current flowing through the coil 39 is rapidly reduced by switching over the switch means 48 between conduction and cutoff. As a result, both a smooth control in which the fluid pressure of the wheel brake BA to BD is linearly controlled by controlling the amount of electric current applied to the coil 39 at an intermediate value between the on and off values, and a rapid control to shift between the on state (valve closed) and the off state (valve open) can be achieved.

An embodiment of the present invention has been described in detail above, but the present invention is not limited to this embodiment and can be modified in a variety of ways without departing from the spirit and scope of the invention described in the claims.

For example, although in the preferred embodiment, the energization control means 46 is provided between the power source 45 and the coil 39, the energization control means 46 may be provided between the coil 39 and ground. Also, the switch means 48 may be provided between the power source 45 and the diode 47.

We claim:

1. A solenoid drive circuit comprising:
a power source;
a coil;
energization control means for controlling the energization/de-energization of the coil, the energization control means being provided either between the power source and the coil or between the coil and ground; and
a diode for allowing electric current to flow toward the power source, the diode being connected between the power source and ground while bypassing the coil; and
switch means provided either between the power source and the diode or between the diode and ground.

2. The solenoid drive circuit according to claim 1, wherein the switch means provides conduction between the diode and ground.

3. The solenoid drive circuit according to claim 2, wherein electric current passing through the coil is gradually decreased when the energization control means stops energizing the coil.

4. The solenoid drive circuit according to claim 1, wherein the switch means cuts off conduction between the diode and ground.

5. The solenoid drive circuit according to claim 4, wherein electric current passing through the coil rapidly reduces when the energization control means stops energizing the coil.
